(19) United States
(12) Patent Application Publication
(10) Pub. No.: US 2023/0092644 A1
(43) Pub. Date: Mar. 23, 2023

(54) Crop Husbandry Composition and Use Thereof

(71) Applicant: Sasol Chemicals GmbH, Hamburg (DE)

(72) Inventors: Ramesh Varadaraj, Katy, TX (US); Ollie Normand, Lake Charles, LA (US); Jennifer Bickel, Lake Charles, LA (US)

(21) Appl. No.: 17/798,370

(22) PCT Filed: Feb. 16, 2021
(86) PCT No.: PCT/US2021/018198

§ 371 Date: Aug. 9, 2022

Related U.S. Application Data
(60) Provisional application No. 62/978,511, filed on Feb. 19, 2020.
(60) Provisional application No. 63/112,255, filed on Nov. 11, 2020.

(51) Int. Cl. A01N 25/04; A01P 13/00; A01P 3/00; A01P 21/00

(52) U.S. Cl. CPC A01N 25/04; A01P 13/00; A01P 3/00; A01P 21/00

(57) ABSTRACT

The invention relates to a crop husbandry composition comprising an alcohol or mixture of alcohols of the formula (I) R₁—OH (I) wherein R₁ is a linear or branched alkyl having a total number of carbon atoms from 18 to 40; and an alcohol alkoxylate or mixture of alcohol alkoxylates of the formula (II) R₂—O—(C₂H_{2z}O)ₓ—H (II) wherein R₂ is a linear or branched alkyl having a total number of carbon atoms from 18 to 40, z has a value of 2 or 3, and x has a value of from 1 to 150. The invention extends to a crop husbandry emulsion and to a field solution comprising said crop husbandry composition, and to a method for the cultivation, treatment, and/or protection of plants, crops, seeds, plant propagation material, aquatic environments, soil, or the like.

### CROSS REFERENCE TO RELATED APPLICATIONS

This application claims priority to US 62/978,511 filed Feb. 19, 2020, and to U.S. 63/112,255, filed Nov. 11, 2020, the disclosures of which are incorporated herein by reference for all purposes.

### FIELD OF THE INVENTION

This invention relates to a crop husbandry composition and use thereof, e.g. for the cultivation, treatment, and/or protection of plants, crops, seeds, plant propagation material, aquatic environments, soil, or the like.

### BACKGROUND OF THE INVENTION

Successful crop husbandry involves a number of activities to ensure crop wellness, including, amongst others: plant pest- and pathogen control, e.g. using pesticides or herbicides, pest repellents or attractants; plant growth regulation; the preservation of crops or parts thereof, e.g. by inhibiting evaporation or mitigating sun damage; effective fertilization; and soil treatment.

Plants, crops, seeds, plant propagation material, and the like are sensitive to damage by UV radiation, e.g. by evaporation of moisture causing dehydration, and/or sun damage. Many compounds applied in crop husbandry are sensitive to damage by solar UV radiation and/or are susceptible to wash-off, e.g. by rain or irrigation, which reduces their efficacy.

A new global trend indicates a shift away from crop husbandry based on synthetic chemicals, towards crop husbandry based on naturally- or microbially derived compounds. However, naturally- or microbially derived compounds may also be sensitive to damage by UV solar radiation and/or are also susceptible to wash-off, which may compromise their efficacy.

A crop husbandry composition for the cultivation, treatment, and/or protection of plants, crops, seeds, plant propagation material, aquatic environments, soil, or the like that at least ameliorates these problems would be beneficial.

### DESCRIPTION OF THE INVENTION

### Crop Husbandry Composition

According to the invention, there is provided a crop husbandry composition, the crop husbandry composition comprising:

an alcohol or mixture of alcohols of the formula (I)

R₁—OH (I)

and an alcohol alkoxylate or mixture of alcohol alkoxylates of the formula (II)

R₂—O—(C_{z}H_{2z}O)ₓ—H (II)
wherein:
R₁ and R₂ are independently of one another a linear or branched alkyl, each having a total number of carbon atoms from 18 to 40, z has a value of 2 or 3, and x has a value of from 1 to 150.

Preferably, R₁ and R₂ are independently of one another a linear or branched alkyl, each having a total number of carbon atoms from 18 to 32. More preferably, R₁ and R₂ are independently of one another a linear or branched alkyl, each having a total number of carbon atoms from 20 to 32.

In a most preferred embodiment, R₁ and R₂ are the same.

Preferably, z is 2, so that the alcohol alkoxylate of formula (II) is an alcohol ethoxylate or the mixture of alcohol alkoxylates is a mixture of alcohol ethoxylates.

Preferably, x has a value of from 10 to 50. More preferably, x has a value of from 15 to 35. Most preferably, x has a value of from 20 to 30.

The alcohol or mixture of alcohols may be produced from a Ziegler process, from a Guerbet process, from the hydrogenation of oleochemical feedstocks, or by separation from oxo alcohols. Preferably, the alcohol or mixture of alcohols is produced from a Ziegler process.

The alcohols or mixture of alcohols may be present in the crop husbandry composition in a mass percentage of from about 60 wt % to about 90 wt %, preferably about 70 wt % to about 80 wt %, based on the total weight of the crop husbandry composition.

The alcohol alkoxylate or mixture of alcohol alkoxylates may be present in the crop husbandry composition in a mass percentage of from about 10 wt % to about 40 wt %, preferably from about 20 wt % to about 30 wt %, based on the total weight of the crop husbandry composition.

The alcohols may be a majority of linear alcohols (greater than 50 wt % linear alcohol), preferably between 60 wt % and 90 wt % linear alcohols, based on the total weight of linear and branched alcohols present.

The crop husbandry composition may include from about 30 wt % to about 45 wt % of C20 linear alcohols, from about 21 wt % to about 39 wt % C22 linear alcohols, from about 4 wt % to about 12 wt % C24 linear alcohols, and from about 1 wt % to about 7wt% C26 linear alcohols, based on the total weight of linear and branched alcohols present.

The alcohol or mixture of alcohols may include additional components comprising paraffins, esters, ethers or mixtures thereof.

The paraffins may include C20 to C32 paraffins. The esters may include C20 to C40 esters. The ethers may include C22 to C40 ethers.

The crop husbandry composition may include from about 0.7 wt % to about 4 wt % paraffins, preferably from about 0.7 wt % to about 2.5 wt % paraffins; from about 1.5 wt % to about 9 wt % esters, preferably from about 4 wt % to about 9 wt % esters; and from about 1 wt % to about 6 wt % ethers, based on the total weight of the alcohols or mixture of alcohols and the additional components.

The alcohols may be present in the alcohol or mixture of alcohols in a mass percentage of from about 65 wt % to about 99 wt %, preferably 70 wt % to 95 wt %, most preferably 75 wt % to 85 wt %, based on the total weight of the alcohols or mixture of alcohols and the additional components.

The additional components may be present in the alcohol or mixture of alcohols in a mass percentage of from about 1 wt % to about 35 wt %, preferably 5 wt % to 30 wt %, most preferably 15 wt % to 25 wt %, based on the total weight of the alcohols or mixture of alcohols and the additional components.

The crop husbandry composition may contain an effective amount of an agrochemically active ingredient.

The agrochemically active ingredient may thus be present in the crop husbandry composition in a mass percentage of from about 0.01 wt % to about 10 wt %, based on the total weight of the crop husbandry composition.

The alcohol alkoxylate or mixture of alcohol alkoxylates may be produced by reaction over a suitable alkoxylation catalyst, for example an alkaline earth metal-based catalyst, or KOH catalyst. Preferably, the alcohol alkoxylate or mixture of alcohol alkoxylates is an alcohol ethoxylate or mixture of alcohol ethoxylates produced by reaction over an alkaline earth metal-based ethoxylation catalyst, most preferably over a calcium-based ethoxylation catalyst.

Advantageously, ethoxylation using an alkaline earth metal-based ethoxylation catalyst is able to produce alcohol ethoxylates with closely controlled varying degrees of ethoxylation (i.e. a varying number of ethoxylate groups) and a narrow ethoxylate distribution.

The difference in the number of ethoxylate groups between the alcohol ethoxylate with the lowest number and highest number of ethoxylate groups may be preferably less than 20, more preferably less than 10.

The alcohol or mixture of alcohols and the alcohol alkoxylate or mixture of alcohol alkoxylates may be in a mass ratio of from about 99:1 to about 51:49. Preferably, the mass ratio of the alcohol or mixture of alcohols to the alcohol alkoxylate or mixture of alcohol alkoxylates is from about 70:30 to about 90:10.

The crop husbandry composition may be solid, e.g. in pastel, pellet or flake form, or the crop husbandry composition may be a paste.

The agrochemically active ingredient may be a pesticide, a herbicide, a fungicide, a plant growth regulator, a nutrient, a fertilizer, a sun protection agent, or any other active ingredient useful in crop husbandry, or any combination of the aforesaid.

The sun protection agent may be or may include a sun-block component, for example, polymers, polymer particles in emulsion, or inorganic materials such as calcium carbonate, clay, silica, or alumina.

The agrochemically active ingredient may be a synthetic chemical agrochemically active ingredient, or a naturally- or microbially-derived agrochemically active ingredient.

In a preferred embodiment of the invention, the agrochemically active ingredient is a pesticide. The pesticide may be a chemical pesticide, a biopesticide or biopesticide precursor, or a mixture thereof.

Where the pesticide is a biopesticide or biopesticide precursor, the crop husbandry composition may include one or more organic acids.

The chemical pesticide may be one or a mixture of chemical pesticides comprising abamectin, acetamiprid, azoxystrobin, bifenthrin, emamectin, fluoxastrobin, kresoxim-methyl, lambda-cyhalothrin, metaflumizone, metalaxyl, picoxystrobin, pyraclostrobin, trifloxystrobin and triticonazole, although any other chemical pesticide suitable for a particular application may be selected.

The biopesticide or biopesticide precursor may be one or a mixture of viable biopesticides or biopesticide precursors comprising bacteria or bacterial spores, a fungi or a fungal spore, algae or an algal spore, viruses, enzymes, nucleic acids, fermentates, plant-incorporated protectants, or gene-silencing (RNAi) pesticides, although any other biopesticide suitable for a particular application may be selected.

Preferably the biopesticide or biopesticide precursor is a bacterial spore. Most preferably, the biopesticide or biopesticide precursor is a bacterial spore of the bacterial species or genus Bacillus., and especially Bacillus subtilis, and/or Bacillus thuringiensis.

Bacterial spores contemplated in this invention include Bacillus aizawai, Bacillus cereus, Bacillus firmus, Bacillus kurstaki, Bacillus lentimorbus, Bacillus licheniformis, Bacillus megaterium, Bacillus popillae, Bacillus pumilus, Bacillus sphaericus, and especially Bacillus subtilis, and/or Bacillus thuringiensis.

Fungal spores contemplated in this invention include those from the Class of Basidiomycetes, Chytridiomycetes, Deuteromycetes, Hyphochytridiomycetes, Oomycetes, Plasmodiophoromycetes, Sordariomycetes, Trichomycetes and Zygomycetes. The fungal species spore is at least one from Arthrobotrys superba, Arthrobotrys irregular, Beauveria bassiana, Fusarium spp., Hirsutella rhossiliensis, Hirsutella thompsonii, Lagenidium giganteum, Myrothecium, Nomuraea rileyi, Paecilomyces lilacinus, Trichoderma, Vericillium lecanii, and/or Verticillium lecani.

The crop husbandry composition may comprise from about 0.01 wt % to about 10 wt % of the chemical pesticide, based on the total weight of the crop husbandry composition.

The crop husbandry composition may comprise from about 0.01 wt % to about 10 wt % of the biopesticide or biopesticide precursor, based on the total weight of the crop husbandry composition.

Where the biopesticide or biopesticide precursor is a bacterial spore, the crop husbandry composition may comprise from about 10² spores/g to about 10⁸ spores/g.

### Crop Husbandry Emulsion

The crop husbandry composition may form a stable emulsion when mixed with water. The stable emulsion formed when mixing the crop husbandry composition with water may be a viscoelastic fluid.

According to a further aspect of the invention, there is provided a crop husbandry emulsion, comprising:
the crop husbandry composition as hereinbefore described; and
water.

When it is referred to “hereinbefore” or “hereinbefore defined” in this specification, it is intended to include all embodiments mentioned before, including the preferred embodiments mentioned before.

The crop husbandry emulsion may be a concentrated aqueous emulsion.

Advantageously, the crop husbandry emulsion is able to achieve a similar suspension loading of the agrochemically active ingredient, with a lower loading of the alcohol alkoxylate (surfactant), and has greater emulsification efficiency to emulsify the agrochemically active ingredient than traditional alkoxylates (e.g. such as those derived via conventional KOH catalysis), since the alcohol alkoxylate is a peaked alkoxylate with a narrow ethoxylate product distribution.

In particular, advantageously the crop husbandry emulsion is able to achieve a similar suspension loading of the sun-block component, with a lower loading of the alcohol alkoxylate (surfactant), and has greater emulsification efficiency to emulsify the sun-block component than traditional alkoxylates (e.g. such as those derived via conventional KOH catalysis), since the alcohol alkoxylate is a peaked alkoxylate with a narrow ethoxylate product distribution.

The crop husbandry emulsion may be a stable self-emulsifying fluid which is a viscoelastic fluid.

The crop husbandry emulsion may form a stable emulsion for a period of at least 3 months at temperatures in the range of from about 5° C. to about 45° C.

The crop husbandry emulsion may be viscoelastic at 25° C. and may have an elastic modulus of at least 75% of the viscous modulus.

The crop husbandry emulsion may include from about 20 wt % to about 99 wt % water, preferably from about 70 wt % to about 99% water, more preferably about 80 wt % to about 99 wt % water, based on the total weight of the crop husbandry emulsion.

The crop husbandry emulsion may absorb or attenuate UV light in the wavelength range from about 190 nm to about 390 nm.

### Field Solution

Typically, the crop husbandry emulsion is diluted prior to use thereof to form a field solution.

Thus, according to a further aspect of the invention, there is provided a field solution, comprising:

the crop husbandry emulsion as hereinbefore described; and

a diluent.

The diluent may comprise at least water.

The field solution may include from about 90wt % to about 99.9wt % diluent, based on the total weight of the field solution.

The field solution may absorb or attenuate UV light in the wavelength range from about 190 nm to about 390 nm.

### Method for Protecting Plants

According to a further aspect of the invention, there is provided a method for the cultivation, treatment, and/or protection of plants, crops, seeds, plant propagation material, aquatic environments, soil, or the like, the method including applying a crop husbandry emulsion or a field solution to the plants, crops, seeds, plant propagation material, aquatic environment, soil, or the like.

The crop husbandry emulsion may be as hereinbefore described.

The field solution may be as hereinbefore described.

The crop husbandry emulsion or the field solution may form a coating on a plant, crop, seed or plant propagation material, aquatic environments, soil, or the like to which it is applied. The coating may absorb or attenuate UV light in the wavelength range from about 190 nm to about 390 nm. The coating may provide protection for the agrochemically active ingredient therein from sun damage, improve sticker- or rainfastness properties which prevents wash-off of the composition and thus also the agrochemically active ingredient therein, as well as protect the plants, crops, seeds, plant propagation material, aquatic environments, soil, or the like to which it is applied from sun damage and/or dehydration.

### Use of the Crop Husbandry Composition

According to a further aspect of the invention, there is provided the use of a crop husbandry composition comprising:
an alcohol of the formula (I); and
an alcohol alkoxylate or mixture of alcohol alkoxylates of the formula (II); for the cultivation, treatment, and/or protection of plants, crops, seeds, plant propagation material, aquatic environments, soil, or the like to which the crop husbandry composition is applied.

The crop husbandry composition may be as hereinbefore described.

Preferably, the crop husbandry composition hereinbefore described, the crop husbandry emulsion hereinbefore described, and the field solution hereinbefore described are for the cultivation, treatment, and/or protection of plants, crops, seeds, plant propagation material, aquatic environments, soil, or the like.

In use, the crop husbandry composition is typically emulsified in water to produce the crop husbandry emulsion hereinbefore described. Typically, the crop husbandry emulsion is further diluted in water to form the field solution hereinbefore described.

In use, the crop husbandry emulsion and the field solution may form a coating on a plant, crop, seed, plant propagation material, aquatic environment, soil, or the like to which it is applied. The coating may provide protection for the agrochemically active ingredient therein (e.g. chemical pesticide, biopesticide or biopesticide precursor, or other UV-sensitive agrochemically active ingredient) from sun damage, improve sticker- or rainfastness properties which prevents wash-off of the composition and thus also the agrochemically active ingredient therein, as well as protect the plants, crops, seeds, plant propagation material, aquatic environments, soil, or the like to which it is applied from sun damage and/or dehydration.

Plants, crops, seed or plant propagation material that may be treated with the crop husbandry composition, crop husbandry emulsion or field solution comprising the crop husbandry composition, may include any food crop intended for human consumption, any animal fodder crops including hay or grass, ornamental plants flowers, trees or lawns.

For example, the plant or crop may be a tobacco plant, or a plant species derived from a tobacco plant.

### Advantages

Advantageously, the crop husbandry composition provides protection for the agrochemically active ingredient (e.g. chemical pesticide, biopesticide or biopesticide precursor, or other UV-sensitive agrochemically active ingredient) therein from sun damage, improves sticker- or rainfastness properties which prevents wash-off of the composition and thus also the agrochemically active ingredient therein, as well as protects the plants, crops, seeds, plant propagation material, aquatic environments, soil, or the like to which it is applied from sun damage and/or dehydration.

Accordingly, crop husbandry emulsions and field solutions which comprise the crop husbandry composition provide similar advantages.

For example, where the crop husbandry emulsion or the field solution contains a pesticide, the coating resulting from the application of the crop husbandry emulsion or the field solution will provide protection against plant pathogens and/or plant pests. The coating resulting from the application of the crop husbandry emulsion absorbs and/or attenuates UV light in the wavelength range from about 190 nm to about 390 nm, and thus also provides protection from sun damage for the pesticide therein, as well as provides protection from dehydration and/or sun damage for the plants, crops, seeds, plant propagation material, aquatic environments, soil, or the like to which the crop husbandry emulsion or field solution is applied.

The inventors believe the protection against sun damage is attributable to a combination of reduced dehydration, reflection of light, and absorption of light, as a result of the coating formed on the plants, crops, seeds, plant propagation material, aquatic environments, soil, or the like to which the crop husbandry composition is applied.

The crop husbandry composition of the present invention advantageously forms a stable emulsion in water.

The crop husbandry composition of the present invention shows low foaming tendencies in emulsion and field solution form, and exhibits strong adhesion to hydrophilic surfaces.

Advantageously, the crop husbandry composition is storage stable in both solid form and in emulsion, and thus also supports the viability and/or stability of microbially-derived agrochemically active ingredients (e.g. bacterial spores) therein during storage.

### EXAMPLES

The invention will now be described with reference to the following non-limiting examples and Figures.

In the Figures:

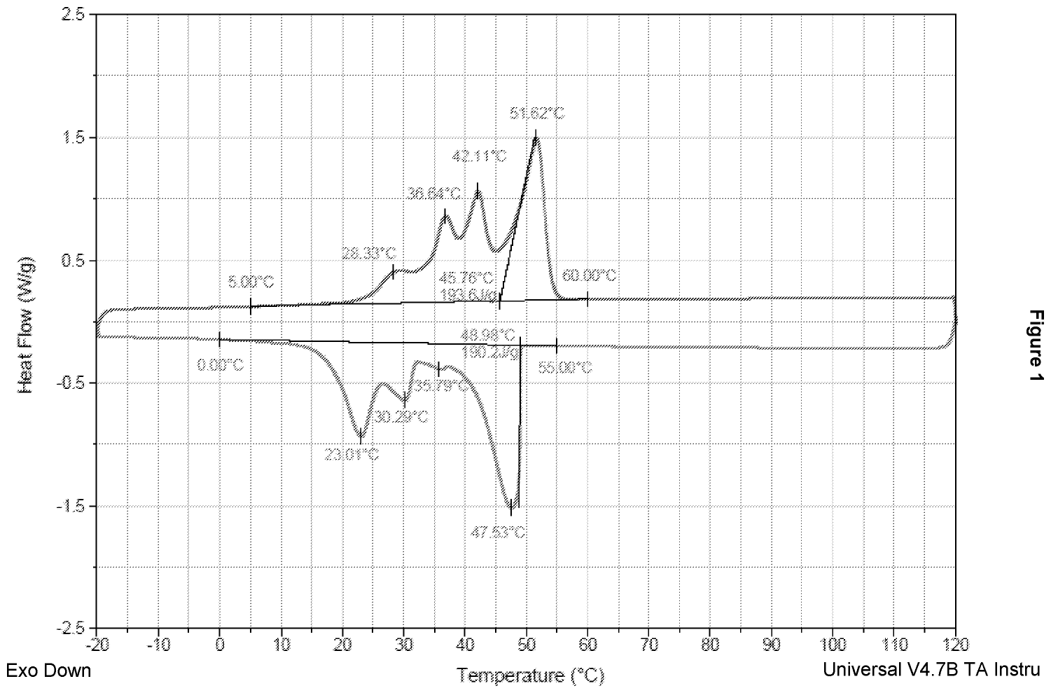

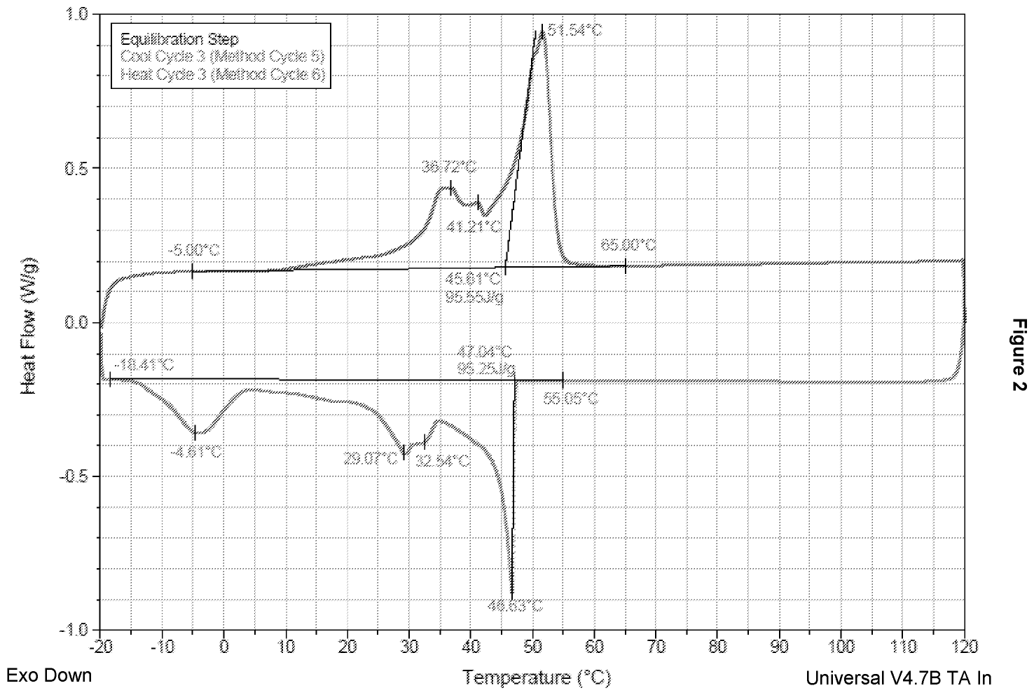

FIG. 1 is a differential scanning calorimetry (DSC) output for Comparative Composition 1;

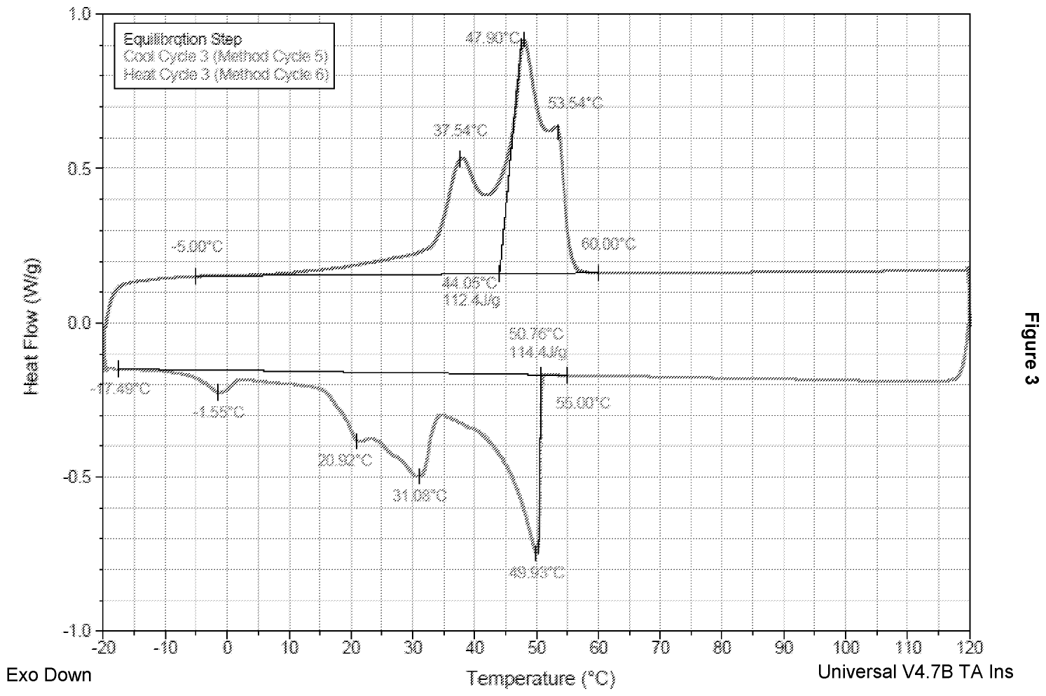

FIG. 2 is a differential scanning calorimetry (DSC) output for Composition 2;

FIG. 3 is a differential scanning calorimetry (DSC) output for Composition 3;

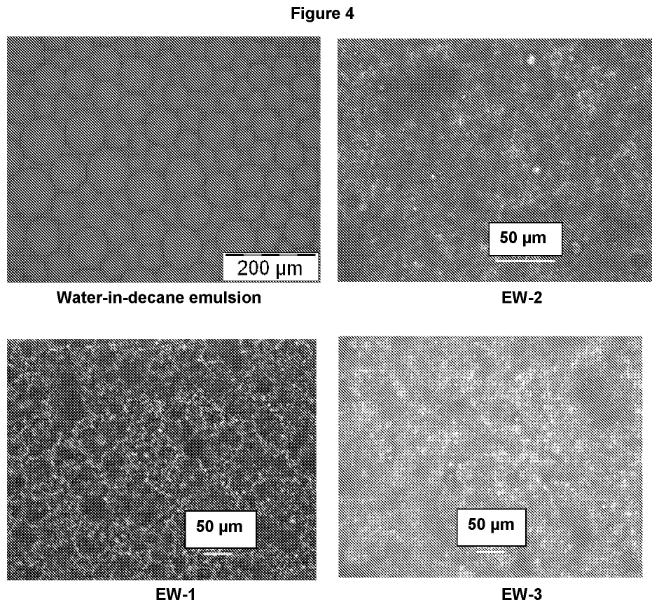

FIG. 4 are optical micrographs of stabilized water-in-decane emulsion (top left), Comparative Emulsion EW1 (bottom left), Emulsion EW2 (top right) and Emulsion EW3 (bottom right);

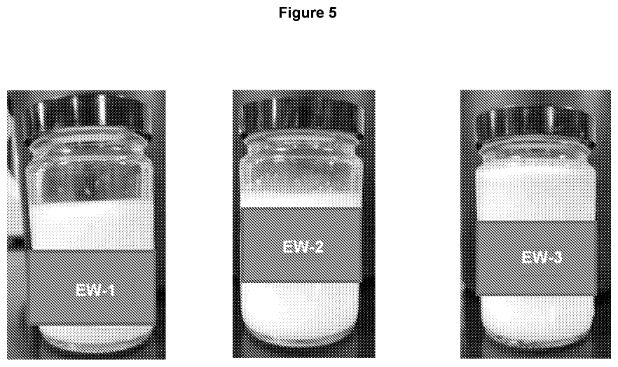

FIG. 5 are images of the emulsions of each of Comparative Composition 1 (left), Composition 2 (center), and Composition 3 (right);

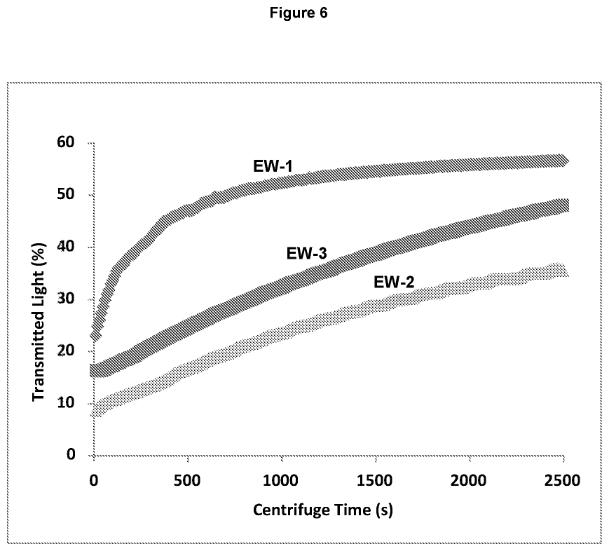

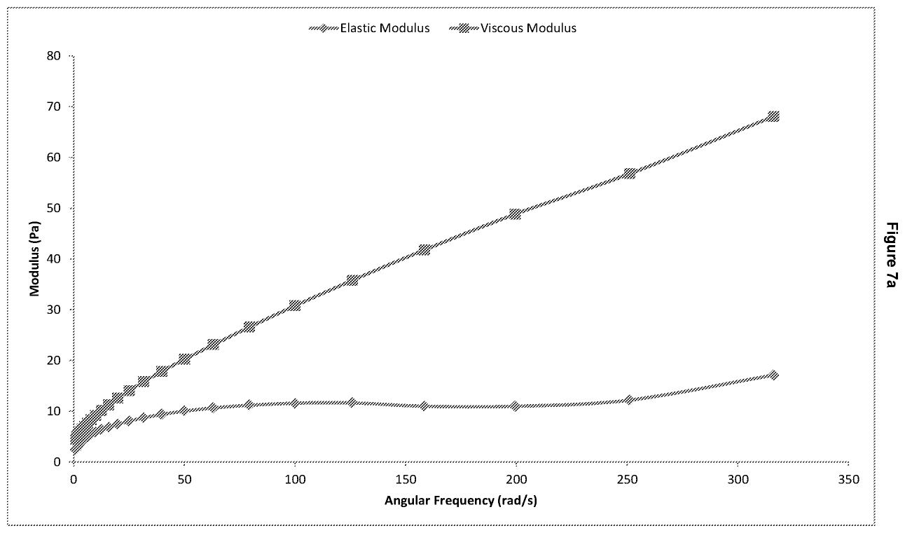

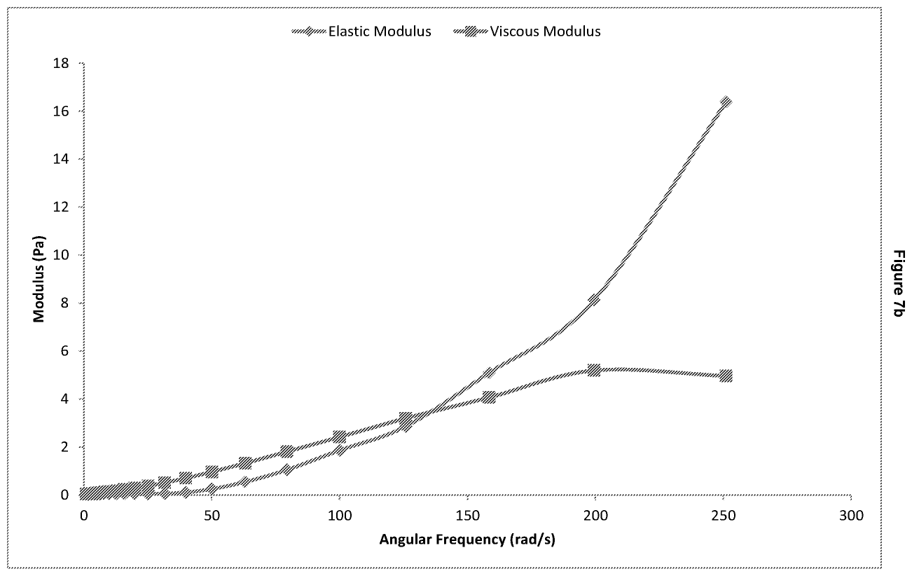

FIG. 6 is a graph of transmitted light as a function of centrifuge time for Comparative Emulsion EW1, Emulsion EW2, and Emulsion EW3;

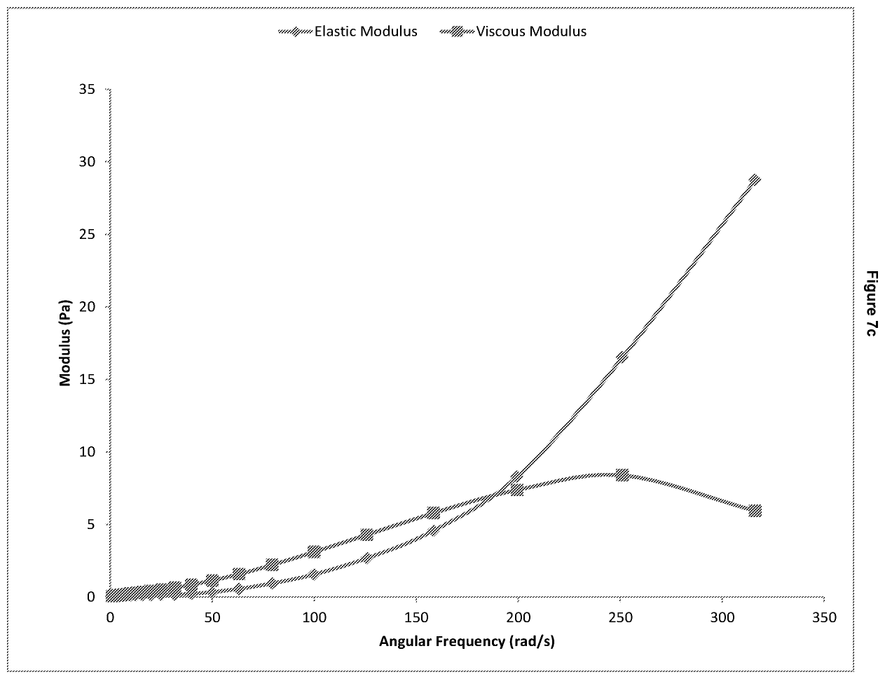

FIGS. 7a, 7b and 6c are graphs of elastic and viscous modulus for Comparative Emulsion EW1, Emulsion EW2, and Emulsion EW3, respectively;

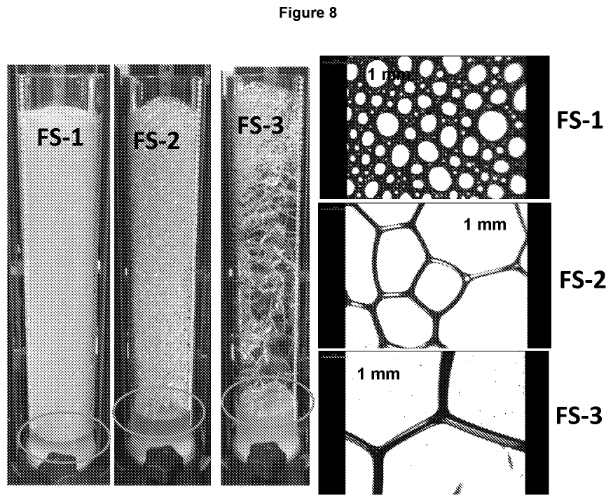

FIG. 8 is an image showing the difference in foaming properties between of Comparative Field Solution FS1, Field Solution FS2, and Field Solution FS3;

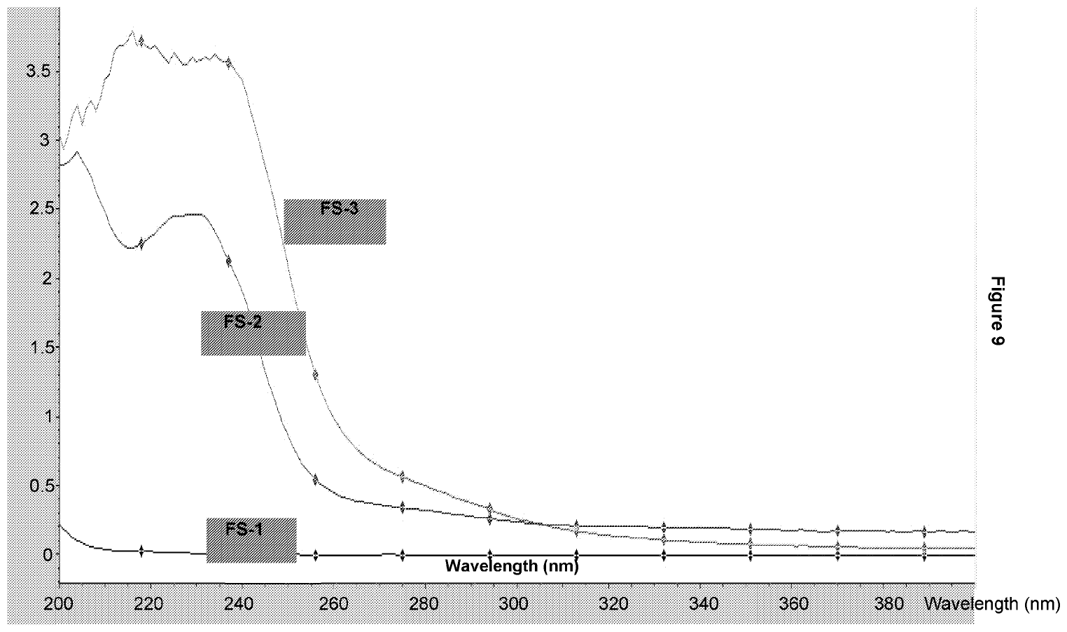

FIG. 9 is a graph showing light absorbance as a function of wavelength (UV range absorbance) for Comparative Field Solution FS1, Field Solution FS2, and Field Solution FS3;

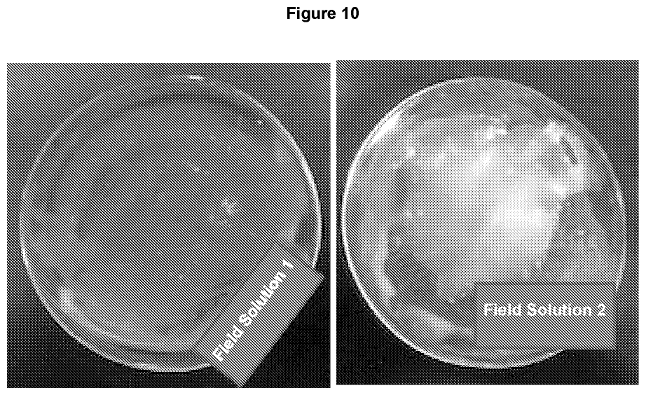

FIG. 10 is an image showing the coating formed by field solutions of Comparative Field Solution FS1 (left) and Field Solution FS2 (right) on a test substrate; and

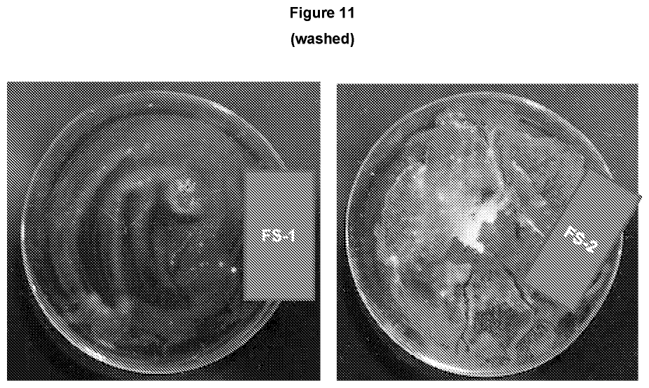

FIG. 11 is a figure showing the corresponding coatings of FIG. 9 after washing with water.

### Analysis of Starting Alcohols

The alcohols used in the preparation of Comparative Composition 1, Composition 2 and Composition 3 were analyzed by gas chromatograph (GC) and results are set out in Table 1. GC measurements were conducted using an Agilent 7890A gas chromatograph with an FID detector and a DB-1 polysiloxane column (100% polydimethyl siloxane).

TABLE 1

| | Alcohol A for | | |
|---|---|---|---|
| | Comparative | Alcohol B for | Alcohol C for |
| | Composition 1 | Composition 2 | Composition 3 |
| Compound | (wt %) | (wt %) | (wt %) |
| C16 alcohol | 61.5 | — | — |
| C18 alcohol | 35.3 | 1.9 | 3.8 |
| C20 alcohol | — | 42.8 | 45.6 |
| C22 alcohol | — | 18.7 | 19.4 |
| C24 alcohol | — | 8.7 | 9.1 |
| C26 alcohol | — | 4.3 | 4.6 |
| C28 alcohol | — | 1.9 | 2.2 |
| C30 alcohol | — | 1.1 | 1.3 |
| Total alcohols | 96.8 | 79.4 | 86 |
| Non-Alcohols | 3.2 | 20.6 | 14 |
| (comprising esters, | | | |
| ethers and paraffins) | | | |

### Solid Crop Husbandry Compositions—Preparation

Three solid crop husbandry compositions were prepared for testing and comparison. Comparative Composition 1 is a comparative composition, whereas Composition 2 and Composition 3 reflect compositions within the scope of the present invention.

| | |
|---|---|
| Comparative | Alcohol A (80 wt %) and C16/ |
| Composition 1 | C18 alcohol ethoxylate (21 EO) |
| | (20 wt %) mixture |
| Composition 2 | Alcohol B (80 wt %) and |
| | ethoxylate (30 EO) of Alcohol B |
| | (20 wt %) mixture |
| Composition 3 | Alcohol C (80 wt %) and |
| | ethoxylate (25 EO) of Alcohol C |
| | (20 wt %) mixture |

Comparative Composition 1 was prepared by mixing 80 wt % Alcohol A (available under the trade name NAFOL 1618) with 20 wt % of a C16/C18 alcohol ethoxylate (21 EO groups) (available under the trade name GALENOL 2100), heating to 70° C., mixing for approximately 2 hours and then allowing to cool to ambient temperature.

Composition 2 was prepared by mixing 80 wt % Alcohol B (available under the trade name ALFOL 20+) with 20 wt % of an alcohol ethoxylate (30 EO groups), prepared by ethoxylation of Alcohol B over a calcium hydrotalcite catalyst (Sasol NOVEL catalyst), heating to 70° C., mixing for approximately 2 hours and then allowing to cool to ambient temperature.

Composition 3 was prepared by mixing 80 wt % Alcohol C (available under the trade name ALFOL 20+) with 20 wt % of an alcohol ethoxylate (25 EO groups), prepared by ethoxylation of the Alcohol C over a calcium hydrotalcite catalyst, heating to 70° C., mixing for approximately 2 hours and then allowing to cool to ambient temperature.

All three compositions were an opaque, waxy solid at ambient temperature.

The thermal properties of each of Comparative Composition 1, Composition 2, and Composition 3 were measured by differential scanning calorimetry (DSC) analysis. The DSC profiles for Comparative Composition 1, Composition 2, and Composition 3 are shown in FIGS. 1, 2 and 3, respectively.

Comparative Composition 1 shows four distinct melting phase transitions, whereas those for Composition 2 and Composition 3 show two melting phase transitions. The enthalpies of the melting phase transitions are significantly lower for the inventive formulations of Composition 2 and Composition 3. The enthalpy of melting for Comparative Composition 1 was 194 J/g, whereas the enthalpies of melting for Composition 2 and Composition 3 were 96 J/g and 112 J/g, respectively. Without wishing to be bound by theory, it is believed that the reduction in enthalpy of melting is due to non-alcohol components which cause a eutectic depression in the energy required in the melting transitions. This is beneficial, for example, in the pellitization of the crop husbandry compositions.

### Emulsions—Preparation and Properties

Comparative Emulsion EW1, Emulsion EW2, and Emulsion EW3 were prepared by mixing each of Comparative Composition 1, Composition 2, and Composition 3, respectively, in water to provide a 3 wt % emulsion of each of the compositions relative to the total mass of the emulsion, heating the emulsion to 70° C. and mixing for approximately 4 hours, to form emulsions Comparative EW1, EW2 and EW3.

Optical micrographs were taken of a water-in-decane emulsion stabilized by a C12 ethoxylate (20E0 groups) commercially available under the trade name ALFOL1214-20E0, as well as for the three emulsions (Comparative EW1, EW2, and EW3) as shown in FIG. 4. It was observed that the emulsions are not typical water-in-oil emulsions, since they exhibit a textured morphology and are birefringent. The optical micrographs are suggestive of a lyotropic liquid crystalline microstructure for the emulsion. The microstructure of the emulsion is unique, and the applicant believes that this contributes to its improved adhesion to surfaces relative to known surfactants and wetting agents.

As shown in FIG. 5, the emulsions were stable for more than 3 months, with no phase separation or creaming occurring. The relative stability of each of the emulsions were determined by centrifugation using a Lumisizer apparatus. A graph of transmitted light as a function of centrifuge time is shown in FIG. 6. EW2 and EW3 exhibited significantly higher stability than Comparative EW1, as evidenced by the smaller slope of the transmitted light versus centrifuge time graph.

The rheological properties for each of the emulsions are shown in FIGS. 7a, 7b, and 7c. Comparative EW1 (FIG. 7a) exhibits viscoelastic behavior. The viscous modulus is 2× to 7×higher than the elastic modulus over the range of angular frequencies measured. Emulsions EW2 (FIG. 7b) and EW3 (FIG. 7c) also exhibit viscoelastic behavior. However, the viscous modulus of EW2 and EW3 is lower than Comparative EW1. Furthermore, the viscous modulus of EW2 and EW3 is only marginally higher than the elastic modulus up to about 150 s⁻¹. Thereafter, the elastic modulus increases significantly. At shear oscillation >150 s⁻¹, EW2 and EW3 are elastic fluids.

This is particularly advantageous, since where the elastic modulus is greater than the viscous modulus, the result is a reduced “bounce-off” effect of the drops of the emulsions (and thus also the corresponding field solutions) from plant leaves during application, e.g. by spraying. The probability that drops of the emulsion or field solution bounce off the leaf surfaces is reduced, and therefore a larger quantity of the sprayed emulsion or field solution sticks to the leaf surfaces during application, improving overall efficacy and effectiveness.

### Field Solutions—Preparation and Properties

Comparative Field Solution FS1, Field Solution FS2, and Field Solution FS3 were prepared by diluting each of Comparative Emulsion EW1, Emulsion EW2, and Emulsion EW3, respectively, in water to provide a 0.3 wt % emulsion of each of the compositions relative to the total mass of the field solution.

The foaming properties of the field solutions were studied and FIG. 8 shows a side-by-side comparison of the type of foam generated by each of the field solutions. Foam properties were measured using a Kruss foam apparatus.

It is clear that FS2 and FS3 not only generate coarse foam, but rapidly defoam upon standing. Coarse (unstable) foam formation and rapid defoaming such as that exhibited by FS2 and FS3 (as compared to Comparative FS1) is desirable in practice, where is it generally desired that foaming is avoided.

In FIG. 9, the UV absorbance spectrum of Comparative FS1, FS2 and FS3 are shown. FS2 and FS3 exhibit strong UV absorbance in the 190 nm to 350 nm wavelength range, compared with Comparative FS1. This is clearly advantageous in mitigating sun damage to plants, crops, seeds, plant propagation material, aquatic environments, soils, or the like to which FS2 and FS3 have been applied, as well as to mitigating sun damage to the agrochemically active ingredient contained in the Field Solutions.

FIG. 10 is an image of representative coatings made from Comparative FS1 (left) and FS2 (right) on a glass slide. Each of the glass slides were sprayed for 30 seconds using a laboratory spray bottle positioned about 6 inches from the slide surface to ensure the same amount of fluid was used to produce an even coating on each glass slide. The transparency of the coatings shown in FIG. 10 is a function of the coating thickness. It is clear that FS2 has more favorable physical properties than Comparative FS1, which allows FS2 to form a thicker coating on the substrate than that coating formed from Comparative FS1.

The coatings were washed with 300 ml distilled water for 5 minutes using a laboratory spray bottle with the spray bottle positioned about 6 inches from the coated surface and photographs taken thereafter. FIG. 11 is an image of the water-washed coatings of FIG. 11. Water washing removes the water soluble ethoxylate and leaves behind the water insoluble alcohol. This washing effect is more pronounced in Comparative FS1, with the result that FS2 leaves behind a thicker coating after washing. In practice, FS2 would provide better protection than Comparative FS1 against dehydration and/or sun damage and retain more agrochemically active ingredient, e.g. pesticide, both directly after first application, and after washing, for example by irrigation or rain.

The experimental data presented herein, individually or collectively, shows that compositions of the invention (Composition 2 and Composition 3) as used in corresponding emulsions EW2 and EW3, and field solutions FS2 and FS3, have clearly superior thermal, emulsion stability, rheological, foaming, UV absorbance, and coating properties over Comparative Composition 1, emulsion Comparative EW1 and field solution Comparative FS1.

1. A crop husbandry composition, the crop husbandry composition comprising:
an alcohol or mixture of alcohols of the formula (I)
R₁—OH (I)
and an alcohol alkoxylate or mixture of alcohol alkoxylates of the formula (II)
R₂—O (C_{z}H_{2z}O)ₓ—H (II)
wherein:
R₁ and R₂ are independently of one another a linear or branched alkyl, each having a total number of carbon atoms from 20 to 32, z has a value of 2 or 3, and x has a value of from 1 to 150, and
wherein the alcohol or mixture of alcohols and the alcohol alkoxylate or mixture of alcohol alkoxylates are in a mass ratio of from about 99:1 to about 51:49.

2. The crop husbandry composition according to claim 1, wherein R₁ and R₂ are the same.

3. The crop husbandry composition according to claim 1, wherein z is 2, so that the alcohol alkoxylate of formula (II) is an alcohol ethoxylate or the mixture of alcohol alkoxylates is a mixture of alcohol ethoxylates.

4. The crop husbandry composition according to claim 1, wherein x has a value of from 10 to 50.

5. The crop husbandry composition according to claim 1, wherein the alcohols or mixture of alcohols is present in the crop husbandry composition in a mass percentage of from about 60 wt % to about 90 wt %, based on the total weight of the crop husbandry composition.

6. The crop husbandry composition according to claim 1, wherein the alcohol alkoxylate or mixture of alcohol alkoxylates is present in the crop husbandry composition in a mass percentage of from about 10 wt % to about 40 wt %, based on the total weight of the crop husbandry composition.

7. The crop husbandry composition according to claim 1, wherein the alcohols present are greater than 50 wt % linear alcohols, based on the total weight of linear and branched alcohols present.

8. The crop husbandry composition according to claim 1, wherein the alcohol or mixture of alcohols includes additional components comprising paraffins, esters, ethers or mixtures thereof.

9. The crop husbandry composition according to claim 8, wherein the crop husbandry composition includes from about 0.7 wt % to about 4 wt % paraffins; from about 1.5 wt % to about 9 wt % esters; and from about 1 wt % to about 6 wt % ethers, based on the total weight of the alcohols or mixture of alcohols and the additional components.

10. The crop husbandry composition according to claim 8, wherein the alcohols are present in the alcohol or mixture of alcohols in a mass percentage of from about 65 wt % to about 99 wt %, based on the total weight of the alcohols or mixture of alcohols and the additional components.

11. The crop husbandry composition according to claim 8, wherein the additional components are present in the alcohol or mixture of alcohols in a mass percentage of from about 1 wt % to about 35 wt %, based on the total weight of the alcohols or mixture of alcohols and the additional components.

12. The crop husbandry composition according to claim 1, wherein the crop husbandry composition contains an agrochemically active ingredient in a mass percentage of from about 0.01 wt % to about 10 wt %, based on the total weight of the crop husbandry composition.

13. The crop husbandry composition according to claim 12, wherein the agrochemically active ingredient is a pesticide, a herbicide, a fungicide, a plant growth regulator, a nutrient, a fertilizer, a sun protection agent, or any combination of the aforesaid.

14. The crop husbandry composition according to claim 1, wherein the alcohol or mixture of alcohols and the alcohol alkoxylate or mixture of alcohol alkoxylates are in a mass ratio of from about 70:30 to about 90:10.

15. A crop husbandry emulsion, comprising the crop husbandry composition according to claim 1, and water.

16. The crop husbandry emulsion according to claim 15, wherein the crop husbandry emulsion includes from about 20 wt % to about 99wt % water, based on the total weight of the crop husbandry emulsion.

17. The crop husbandry emulsion according to claim 15, wherein the crop husbandry emulsion is a stable self-emulsifying fluid which is viscoelastic at 25° C. and has an elastic modulus of at least 75% of the viscous modulus.

18. The crop husbandry emulsion according to claim 15, wherein the crop husbandry emulsion absorbs or attenuates UV light in the wavelength range from about 190 nm to about 390 nm.

19. A field solution, comprising the crop husbandry composition according to claim 1 and water, wherein the field solution includes from about 90 wt % to about 99.9 wt % water, based on the total weight of the field solution.

20. The field solution according to claim 19, where in the field solution absorbs or attenuates UV light in the wavelength range from about 190 nm to about 390 nm.

21. A method for the cultivation, treatment, and/or protection of plants, crops, seeds, plant propagation material, aquatic environments, or soil, the method including applying a crop husbandry emulsion according to claim 15 to the plants, crops, seeds, plant propagation material, aquatic environment, or soil.

22. The method according to claim 21, wherein the crop husbandry emulsion forms a coating on the plant, crop, seed or plant propagation material, aquatic environments, or soil, to which it is applied.

23. The method according to claim 21, wherein the coating absorbs or attenuates UV light in the wavelength range from about 190 nm to about 390 nm.

24. (canceled)

25. A method for the cultivation, treatment, and/or protection of plants, crops, seeds, plant propagation material, aquatic environments, or soil, the method including applying a field solution according to claim 19 to the plants, crops, seeds, plant propagation material, aquatic environment, or soil.
